(19) United States
(12) Patent Application Publication
(10) Pub. No.: US 2017/0190322 A1
(43) Pub. Date: Jul. 6, 2017

(54) AIR COMPRESSOR AND RESERVIOIR FOR TOPPING OFF LOW PRESSURE TIRES

(71) Applicant: Robert D. Fish, Tustin, CA (US)

(72) Inventor: Robert D. Fish, Tustin, CA (US)

(21) Appl. No.: 15/467,873

(22) Filed: Mar. 23, 2017

Related U.S. Application Data
(62) Division of application No. 12/166,544, filed on Jul. 2, 2008.
(60) Provisional application No. 60/947,579, filed on Jul. 2, 2007.

(51) Int. Cl. B60S 5/04; F04C 25/00; F04B 41/02; F04C 2/16

(52) U.S. Cl. CPC B60S 5/043; F04C 2/16; F04C 25/00; F04B 41/02

(57) ABSTRACT

A small volume capacity pump is used to pressurize a small air tank, and the tank is used to top off pressure in an automobile tire or other receptacle. The tank preferably has a reservoir measuring 200-300 cc, and is pressurized to at least 500 psi. The pump preferably has a low volume capacity of 200-300 cc/min, thus requiring at least 15-45 minutes to refill the reservoir to its full operating pressure when empty. A pump can be operated by a DC or AC motor, which can be housed along with, or separately, from the pump. Especially preferred embodiments also include an automatic pressure regulator that can be set to deliver a desired pressure to a receiving device, and a trigger that controls release of air from the tank to the regulator.

This application is a divisional application of U.S. patent application Ser. No. 12/166,544, titled “AIR COMPRESSOR AND RESERVOIR FOR TOPPING OFF LOW PRESSURE TIRES”, filed Jul. 2, 2008 by inventor Robert F. Fish, which application claims priority to U.S. provisional application Ser. No. 60/947579, filed Jul. 2, 2007, both of which are incorporated herein by reference herein in their entirety.

### FIELD OF THE INVENTION

The field of the invention is tire pumps (152/417).

### BACKGROUND

It is well known that automobile tires, sports balls, pool floats and other pressurized devices tend to leak over time, and require additional air from time to time to maintain a proper air pressure. The problem is especially significant for automobile tires, where (a) tires tend to lose about one pound per square inch (psi) per month, and (b) even moderately low tire pressures (3-4 psi below target) result in noticeably lower gas mileage and tire life.

The usual method of maintaining automobile tire pressure is to use compressed air sources at a gas or service stations. Unfortunately, such sources are often either impractical or completely unavailable. Gas stations typically have only a single air hose for customer usage, and one or more other customers may well have to wait in line for an uncomfortable period of time to use the air hose. Another problem is that tire pressure should be checked when the tires are cold, or at least substantially cold. By the time a car owner remembers to check the pressure, or reaches a gas station with a working, available air hose, the tires are often no longer cold.

Other known options are too inconvenient for many car owners. One could, for example, keep a hand pump at home to top off the air pressure in an automobile. But the 32-34 psi pressures that are standard for automobile tires typically require a foot operated pump, which is too awkward or otherwise inconvenient for many users. One could alternatively use a commercial or home compressor unit supplied with an air tank, but such compressors are AC powered, and typically have tank capacities from 3 to 300 gallons. They are far too expensive and too bulky for many automobile owners, and are certainly too bulky to be carried about in an automobile by a typical user.

It is also known to use portable gas-filled canisters to repair flats in automotive tires. But such canisters often contain a sealing compound, which one would not want to use when merely topping off pressure in a tire. Pressurized canisters without sealing compound are also known, but they are impractical. PowerTank™ and other liquid CO₂ canisters are convenient, and useful for emergency use, but are quite expensive in the long run if used to top off tire pressure because they are not refillable by a typical user. U.S. Pat. No. 4,653,550 to Crowley (March 1987) and U.S. Pat. No. 3,934,622 to Vitack et al. (January 1976) teach refillable compressed air bottles that are sized and dimensioned to be carried about in an automobile. But they have a relatively large size because the maximum pressure afforded by gas stations and home compressors is only about 90 psi.

It is also known to use a portable mini-compressor to supply air to a tire. Many such devices are DC powered, and sized to be carried about in the trunk of an automobile. But even those devices are too bulky because they are intended for use in refilling a flat tire. In addition, such devices are inconvenient to use and store because they need to have long power cords or air tubes (5 meters or more) to reach each of the tires of a typical automobile.

Thus, in reviewing the prior art it is apparent that no one has yet solved the problem of producing a convenient device for topping off automobile tire pressure.

### SUMMARY OF THE INVENTION

The present invention provides methods that use a small compressed air tank along with a portable electric pump to top off pressure in a tire or other receptacle, in which an air reservoir with a relatively small reservoir is refilled using a low volume, high pressure air pump.

In preferred embodiments the reservoir has insufficient capacity when at full pressure to refill a typical flat automobile tire. In most cases this means that the reservoir has a main cavity of no more than a liter, more preferably between 100 and 750 cc, and still more preferably between 200 and 300 cc. The reservoir would, however, store high pressure air, typically at least 500 psi, more preferably 700-1,200 psi, and still more preferably 800-1,000 psi. Unless a contrary intent is apparent from the context, all ranges recited herein are inclusive of their endpoints, and open-ended ranges should be interpreted to include only commercially practical values.

Also in preferred embodiments the pump has a relatively low volume capacity (pumping only about 100-800 cc/min, and more preferably 200-300 cc/min, thus requiring at least 15-45 minutes to refill the reservoir to its full operating pressure when empty. To the best knowledge of the inventor, there are no commercially available pumps that meet those specifications, but engineering of satisfactory screw pumps is thought to be well within the ordinary skill of those in the art once it is appreciated that such pumps would be useful.

The pump can be operated by any suitable motors, including both DC and AC motors. Where a DC motor is used, the power cord would typically have a male cigarette-lighter plug on one end, and can be relatively short (less than 2 meters and more preferably less than a meter) because there is no need to run the power cord out to the tires when inflating them.

Especially preferred embodiments also include an automatic pressure regulator that can be set to deliver a desired pressure to a receiving device.

In preferred methods, a user removes the air tank from the vehicle, transfers air from the tank to the tire, and then uses an electrical system of the vehicle to operate a pump that provides compressed air to the tank. Preferred tanks are quite relatively small, generally having a cavity less than one liter, more preferably less than ¾ liter, still more preferably less than ½ liter, and most preferably between 200 and 400 cc. Such tanks can advantageously weigh less than a pound, more preferably less ½ pound.

The pump can connect to the electrical system of the vehicle in any suitable manner, but most preferably using a cigarette lighter plug or other dc connection. The power cord can be hard-wired to the air tank housing, or more preferably has an electrical connector on the opposite end from the cigarette lighter plug, so that the housing can be removed from the vehicle and used to top off the tires, all while the electrical system of the vehicle is disconnected from the pump. To that end the power cord can be relatively short, perhaps only a foot or two in length. Longer power cords are contemplated, including those longer than 30 inches, but such lengths are thought to be unnecessary since the power cord need not extend from the cigarette lighter all the way out to the tires.

In still other contemplated embodiments, the housing that includes the pump can be separated from the housing that includes the air tank, and coupled via high-pressure air hose connection.

Because the air tank is relatively small, it is possible that considerable air pressure can be lost while trying to seat the pressure hose from the tank onto the pressure stem of the tire. One contemplated way of addressing that problem is to pressurize the hose only while a button or other trigger mechanism is being operated. Another contemplated way of addressing the problem of limited air supply is by providing a pressure regulator that delivers a pre-set pressure to the tire. Thus, for example, a user might set the unit at 35 pounds, connect the hose to the tire stem, and then actuate the trigger. Doing so will deliver sufficient air to the tire to provide an equalized pressure of 35 pounds±some tolerance.

Tanks are preferably small enough to fit in a standard automobile glove compartment, Typical contemplated tank sizes are 200-500 cc (cm³), but could go up to a liter or more, depending on the shape. Suitable tanks should have sufficient capacity to top off one or more tires that are several pounds below a target pressure. For relatively small tanks this means that the tanks must be pressurized 500-1200 psi, or even higher pressures, and must have sufficient wall strength to withstand such pressures. For such high pressures, and especially since the tank might well be stored in the glove compartment of a hot car, it is also considered advantageous to include a pressure relief valve.

The hose that delivers pressurized air from the tank to the tire need not be very long, and indeed hoses longer than about 10 inches can be problematic in that the extra hose is takes up valuable space in storage. Preferred hoses (air conduits) have lengths of no more than 12 inches.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a perspective view of a contemplated air topper unit that includes tank, pump and motor in a single portable unit.

FIG. 2 is a plan view of the air topper unit of FIG. 1, with the top cover removed.

FIG. 3 is a perspective view of an alternative air topper unit that includes a tank and pump in a single portable unit, and a motor in a separable base unit.

FIG. 4 is a flow chart of a preferred method, along with various options.

### DETAILED DESCRIPTION

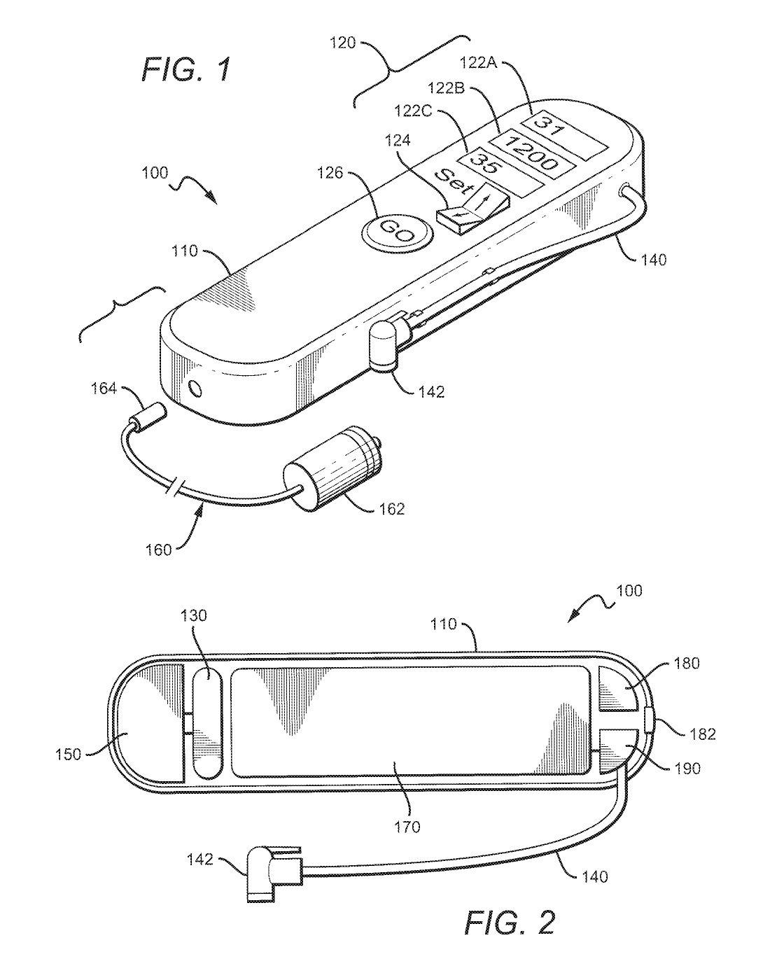

In FIGS. 1 and 2, an air topper unit 100 generally includes a housing 110, controls and display section 120, a compressed air tank 170, an air hose 140, a motor/compressor 150 and a power cord 160.

The housing 100 can be any suitable size and shape, but is preferably sized and dimensioned to fit comfortably within a glove compartment of an automobile. A flattened structure is currently preferred, measuring 15-20 cm long, 3-4 cm high, and about 10 cm wide. Alternative housing shapes are also contemplated, including for example, a generally cylindrical structure, but such shapes are thought to less desirable because they tend to pack inefficiently in a glove compartment.

Controls and display section 120 generally includes three displays 122A, 122B, 122C, an up/down toggle 124, and a “GO” button 126. In this particular embodiment the display 122A show the pressure in the tire, display 122B shows the pressure in the tank, and display 122C shows a desired pressure for the tires, set by toggle 124. Other configurations are also contemplated, including for example use of a single display (not shown) that could be used to provide information otherwise shown in the three displays.

The air hose 140 is preferably a standard air hose with a standard fitting 142 for coupling with a standard tire valve stem (Schrader or Presta), but is intended to generically represent all suitable hoses and associated connectors. For example, fitting 142 should be viewed as having internal threads, but non-threaded connectors are also contemplated. Similarly, the DC power connector 160 is preferably a standard 12 volt cigarette lighter plug, but is intended to generically represent all suitable plugs regardless of voltage and current type. Preferred hoses are no longer than about 4, 6, 8, 10 or 12 inches.

Power cord 160 generally includes a male adapter 162 for a cigarette lighter at one end, and a pin type connector 164 at the other end. The portion of the cord between the two connectors is depicted with a “∥” mark to show that the cord is actually longer than literally shown in the figure. The power cord 160 can be relatively short, perhaps only a foot or two in length. Longer power cords are contemplated, including those longer than 30 inches, but such lengths are thought to be unnecessary since the power cord need not extend from the cigarette lighter all the way out to the tires. In especially preferred embodiments, the combined length of the power cord 160 and the hose 140 is no more than 48 inches, more preferably no more than 36 inches, and still more preferably no more than 30 inches.

In other contemplated embodiments (not shown), the power cord can be hard-wired to the housing. In still other contemplated embodiments (not shown), an ac power cord can be used, or a dc power cord with a distal connector other than a male cigarette lighter adapter.

In FIG. 2, housing 110 is seen to house a motor/compressor 150, controller 130, tank 170, battery 180, and pressure controller 190. Those skilled in the art will appreciate that the design shown is illustrative only, and could be modified in any number of different ways to achieve the intents and purposes described herein.

Controller 130 operates the motor/compressor 150 to fill the tank to a suitable pressure, typically at least 500 psi, more preferably 700-1,200 psi, and still more preferably 800-1,000 psi. Controller 130 and motor/compressor 150 are both likely powered by current passing through the plug 162, but with advances in power storage technology, could theoretically be powered by an onboard power source such as a battery or supercapacitor. Motor/compressor 150 preferably has a low volume capacity, which might, for example, require several hours to fill a tire for a compact automobile, and at least 15-45 minutes to more than an hour to fill the tank 170 to a full operating pressure of 1200 psi when substantially empty. The term “full operating pressure” is used herein to mean the maximum design pressure of the device when the tank is equalized at 70° C. The tank is, of course, designed to safely withstand much higher pressures, e.g., 3,000 psi for safety reasons.

Viewed from another perspective, motor/compressor 150 would preferably pump only about 100-800 cc/min, and more preferably 200-300 cc/min.

The compressor portion of motor/compressor 150 could operate using any suitable technology, including for example, reciprocating, rotary, or screw designs. Similarly, compressors could be either single-stage or multistage. Because of the high pressures required, motor/compressor 150 likely uses a multistage compressor component.

It is contemplated that only a small motor is needed. While not wishing to be limited to the validity of any particular theory or calculation, it is contemplated that filling a 300 cc tank to 1,200 psi would require 2,500 Joules, which equates to a 1 Watt motor working for 40 minutes. Even assuming that the same amount of energy is lost as heat because of the non-adiabatic compression, a 2 Watt motor should be sufficient.

Tank 170 is simply an air tank, which receives compressed air from motor/compressor 150, and delivers compressed air to air hose 140. Tank 170 is preferably flattened, but could also be cylindrical, and it should be appreciated that tank 170 could have multiple cavities, and could be replaced by multiple tanks. A key feature is that the tank has a low volume capacity, preferably no more than a liter, more preferably between 100 and 750 cc, and still more preferably between 200 and 300 cc. Those sizes are especially contemplated for automobiles, and smaller sizes (100-200) cc tanks contemplated for motorcycles, with 40-75 cc tanks contemplated for bicycles. Some contemplated tanks define a compressed air cavity having a volume of at least 350 cc, while others define a compressed air cavity having a volume of no more than 350 cc and still others define a compressed air cavity having a volume of no more than 500 cc.

Battery 180 can have any suitable capacity. This capacity can be used to provide sufficient energy to operate the displays 122A, 122B, 122C, and perhaps power a buzzer or beeper to sound an intermittent alarm when the tank needs to be re-pressurized, when the tank is full, and when the desired pressure is reached in the tire. In the particular embodiment of FIGS. 1, 2, the battery 180 also powers diode flashlight 182, which can be triggered by the “GO” button 126.

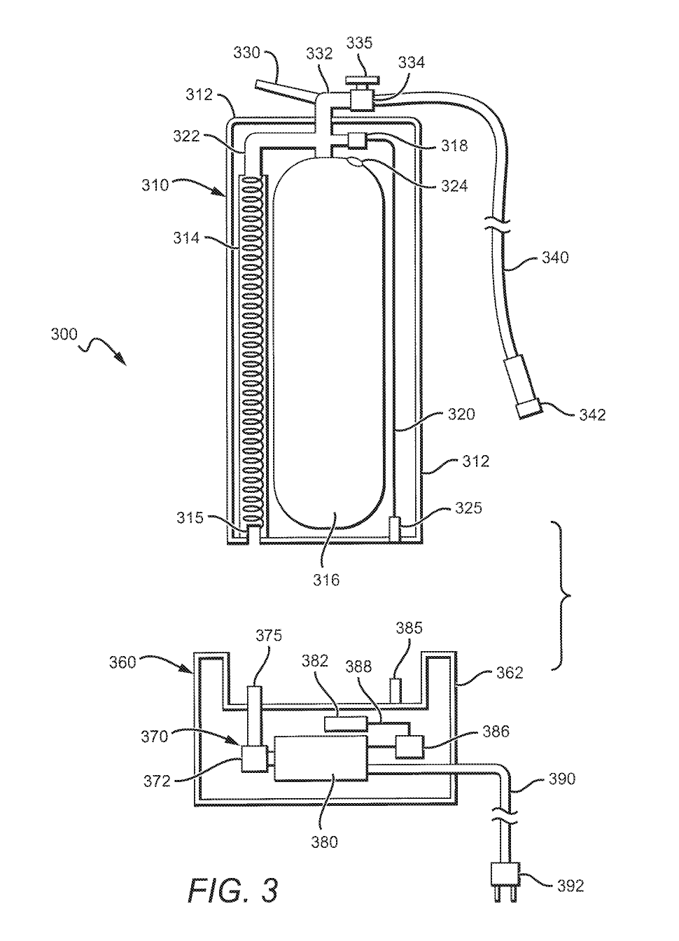

FIG. 3 generally depicts a device comprising a portable unit 310 and a base unit 360.

The portable unit generally comprises a housing 312 that encloses a screw pump 314, a compressed air reservoir (tank) 316 with emergency pressure relief 324, a pressure sensor 318, connecting wires 320 and wire jack 325, and connecting pressure lines 322. The screw pump is driven by turning driver socket 315.

To the best knowledge of the inventor, there are no commercially available pumps that are small enough to satisfy the completed use herein, and yet can still can pump to 1,200 psi or more, or even to 500 psi. But screw pump technology is well understood, and satisfactory screw pumps could be engineered if those skilled in the art had appreciated that such pumps would be useful.

Outside the housing 312 is a pressure regulator 334 with pressure setting knob 335, a trigger 330 that operates valve 332 to control release of air through the regulator 334, air hose 340 and female connector 342. A preferred pressure regulator is Genuine Innovations™ model #SA00113.

The base unit 360 generally includes a housing 362, a drive train 370, motor 380, electronic controller 382, power cord 390 and male power plug 392. The drive train generally includes right angle gearing 372, and male driver 375 that couples with driver socket 315. Controller 382 receives an electrical signal from sensor 318 through pin 385, and operates solenoid 386 to bring power to the motor 380 via power line 388.

In operation, the bottom of the portable unit 310 is inserted in to the top of the base unit 360. That step engages the driver 375 with the driver socket 315 so that the motor 380 can drive the screw pump 314. That step also engages the pin 385 with jack 325, so that the controller 382 receives an electrical signal from sensor 318, and can control the motor 380 to avoid over-pressurizing the tank.

The description above with respect to tank size and pressure, and pump/motor capacity are all applicable to FIG. 3. This embodiment, however, is thought to be advantageous where the reservoir/tank size and pressure make it impractical to include both the pump and motor inside the reservoir/tank. Thus, it is contemplated that user would store the portable unit 310 in the glove compartment of his/her automobile, SUV or truck, or perhaps in a carrying case of a motorcycle or bicycle, use the unit as needed to top off one or more tires, and then return the portable unit 310 to the base 360 for re-pressuring the reservoir/tank.

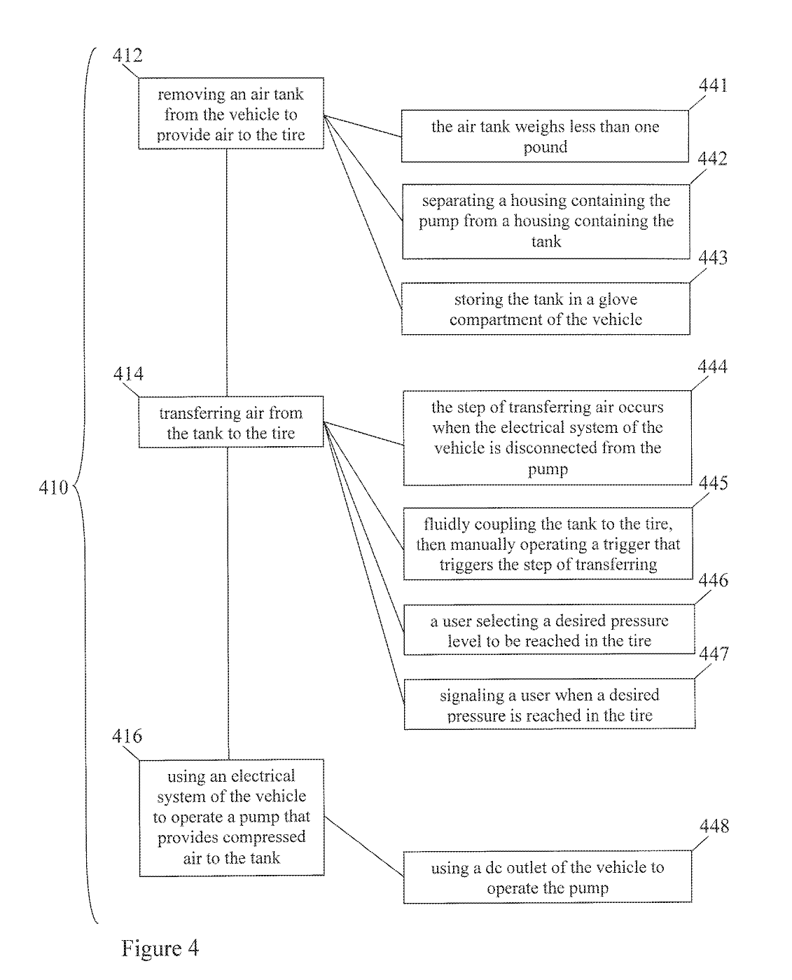

In FIG. 4, a method 410 of topping off air in a tire includes step 412, removing an air tank from the vehicle to provide air to the tire, step 414, transferring air from the tank to the tire, and step 416, using an electrical system of the vehicle to operate a pump that provides compressed air to the tank.

A preferred method contemplates air tanks of any suitable weight, but in preferred embodiments the air tank can weigh less than one pound (option 441), allowing for easier transport and use. It is also advantageous to have a tank small in size, so that it can be conveniently stored in a small space such as the glove compartment of a vehicle (option 443). This allows for convenient storage and transport, as well as quick access to the apparatus when needed.

In other contemplated embodiments, the pump and tank are contained in separate housing as shown in option 442. A user can detach the tank from the pump before topping off air in a tire, so that the mobility of the tank is not constrained by the reach of the pump's power cord. The pump can be used separately at a later time to fill the tank with air.

A preferred method contemplates that it is advantageous for Step 414, transferring air from the tank to the tire, to be accomplished while the electrical system of the vehicle is disconnected from the pump (option 444). Option 444 allows for a shorter hose and power cord length because the pump and air tank can be operated independent of one another. Therefore, the tank will not need to be tethered to the cigarette lighter or other dc power source in order to transfer air to the tire. The power cord only needs to be long enough to stretch from the pump to the power source, and the hose only needs to be long enough to stretch from the tire to the tank.

Step 414 can also be accomplished by fluidly coupling the tank to the tire, then manually operating a trigger that begins the step of transferring as shown in option 445. This would allow the user to first seat the hose onto the tire pressure stem and then actuate the trigger, preventing the loss of air pressure from the hose.

Options 446 and 447 contemplate that a user can select a desired pressure level (e.g. 32 psi, 35 psi, or other any other pressure level suitable to the particular tire) to be reached in the tire. Any suitable means of selecting a pressure level are contemplated, such as turning a dial, pressing keys, or entering an amount on a digital display using a touch screen.

The device will signal a user when the desired pressure is reached in the tire. The signal can include any type of alarm such as a buzzer, beeper, or flashing light.

Step 416 contemplates using an electrical system of the vehicle to operate a pump that provides compressed air to the tank. As shown in option 448, a dc outlet of the vehicle or any other suitable dc connection can be used to operate the pump.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification and claims refer to at least one of something selected from the group consisting of A, B, C . . . and N, the text should be interpreted as requiring only one element from the group, not A plus N, or B plus N, etc.

I claim:

1. A method for topping off low pressure tires comprising the steps of:
providing a pressurized tank having a pressure of at least between 500-1200 psi and a usable volume of between 40-300 cc;
transferring air from the pressurized tank to a tire, yielding a depressurized tank; and
using current from a motor vehicle to refill the depressurized tank to a pressure of at least between 500-1200 psi, wherein it takes at least 15 minutes to refill the depressurized tank.

2. The method of claim 1, wherein the tire is one of a bicycle tire, a motorcycle tire, or an automobile tire.

3. The method of claim 1, wherein the pressurized tank further comprises a pneumatic screw pump.

4. The method of claim 3, wherein the pneumatic screw pump pumps at a rate no more than 300 cc/min.

5. The method of claim 3, wherein the pneumatic screw pump comprises a 1 Watt motor.

6. The method of claim 3, wherein the pressurized tank further comprises a power source for the pneumatic screw pump, comprising at least one of a battery or a supercapacitor.

7. The method of claim 6, further comprising the step of charging the power source.

8. The method of claim 1, wherein it takes at least 45-60 minutes to refill the depressurized tank.

9. The method of claim 1, wherein the pressurized tank weighs less than ½ pound.

10. The method of claim 1, wherein the usable volume is between 40-75 cc.

11. The method of claim 1, wherein the usable volume is between 100-200 cc.

12. The method of claim 1, wherein the pressurized tank has a pressure up to 3000 psi.

13. The method of claim 1, further comprising a step of storing the pressurized tank in a glove compartment of a vehicle.

14. The method of claim 1, wherein the step of transferring further comprises fluidly coupling the pressurized tank to the tire, and then manually triggering the transfer.

15. The method of claim 1, wherein the pressurized tank has a flattened shape.

16. The method of claim 1, further comprising a step of selecting a desired pressure for the tire.
